(19) United States
(12) Patent Application Publication
(10) Pub. No.: US 2026/0075306 A1
(43) Pub. Date: Mar. 12, 2026

(54) Digital Processing of Audio to Identify Voices in Fields of View

(71) Applicant: Apple Inc., Cupertino, CA (US)

(72) Inventors: Joshua D. Atkins, Lexington, MA (US); Christopher L. Flick, San Jose, CA (US); Lasse Vetter, Henstedt-Ulzburg (DE); Symeon Delikaris Manias, Culver City, CA (US); Stephen J. Nimick, Los Angeles, CA (US); Majid Mirbagheri, Los Angeles, CA (US); Shadi Pir Hosseinloo, Cupertino, CA (US)

(21) Appl. No.: 19/319,295

(22) Filed: Sep. 4, 2025

Related U.S. Application Data
(60) Provisional application No. 63/691,791, filed on Sep. 6, 2024.

(51) Int. Cl. H04N 23/63; G10L 21/0208; H04S 7/00

(52) U.S. Cl. CPC H04N 23/631; G10L 21/0208; H04S 7/301; H04R 2499/11; H04S 2400/11; H04S 2420/11

(57) ABSTRACT

A device may include a front camera, a rear camera, one or more microphones, and one or more processors. The device can receive a front video signal from the front camera, a rear video signal from the rear camera, and an audio signal from the one or more microphones. The device can digitally process the audio signal to identify voices of persons captured in a fields of view of the cameras, and ambient sounds of sound sources outside of the fields of view. The device can generate an audio track to enable an audio renderer to render the voices, and selectively attenuate the ambient sounds, during playback of the front video signal and the rear video signal concurrently. The device can store a video container including the front video signal, the rear video signal, and the audio track. Other aspects are also described and claimed.

### RELATED APPLICATIONS

This application claims the benefit of priority of U.S. Provisional Application No. 63/691,791, filed Sep. 6, 2024, which is herein incorporated by reference.

### BACKGROUND

### Field

This disclosure relates generally to capturing video recordings by a device and, more specifically, to digital processing of audio to identify voices in fields of views. Other aspects are also described.

### Background Information

Portable consumer electronic devices such as smartphones and tablet computers may be used to make video and audio recordings of various types of scenes or events. For example, the recording session may capture an interview with a person in a noisy background, a sporting venue with roaring crowd noise, a nature scene outdoor, etc.

Although different recording modes, such as focus mode, narrative mode, etc., may be used to enhance the quality of rendered video when recording different types of scenes or events, it is challenging to enhance the rendered audio quality. For example, due to the microphones being co-located on the recording smartphone rather than near the audio source, audio recording of a dialogue may be degraded by an interfering voice, background noise, sound reverberation, level imbalance, etc. Adopting audio processing techniques as a function of the recording modes may help to maintain audio fidelity, but it remains difficult to achieve near-cinematic audio quality in different audio environments.

### SUMMARY

Implementations of this disclosure include digitally processing an audio signal generated with a video recording, concurrently, in real time, with capture of the video recording, to calculate statistics of the audio signal. The statistics may be used to generate metadata immediately after stopping the capture of the video recording. The metadata may then be written to a track of a video container (e.g., a movie file) that also contains the original audio and video signals (unprocessed) from the video recording in separate tracks. The metadata may enable an efficient, low power capture of audio rendering data by a device that subsequently enables audio rendering further downstream. Then, at a later time, an audio renderer of an audio/video player (AVP) can render the original audio signal (unprocessed) based on mixing that utilizes the metadata. In some cases, the metadata may be used to generate a video container that includes the video signal and a mixed audio signal to pre-render audio for playback (e.g., a second movie file, or derivative file).

Some implementations may include a method for digital processing of audio for a video recording, including: receiving a video signal of a scene being produced by a camera of a device and an audio signal of the scene being produced by one or more microphones of the device; while capturing a video recording based on the video signal and the audio signal: digitally processing the audio signal to determine that a first segment of the audio signal is in a first sound class and a second segment of the audio signal is in a second sound class; and determining a plurality of features of the audio signal, wherein the plurality of features are determined based on the first segment, the second segment, the first sound class, and the second sound class; generating metadata based on the plurality of features after capturing the video recording, wherein the metadata comprises a plurality of parameters to remix the first segment and the second segment in a mixed audio signal for the video recording; and storing a video container comprising the video signal, the audio signal, and the metadata.

Some implementations may include a device including a camera, one or more microphones, a memory, and one or more processors. The one or more processors may execute instructions stored in memory to: receive a video signal of a scene being produced by the camera and an audio signal of the scene being produced by the one or more microphones; while capturing a video recording based on the video signal and the audio signal: digitally process the audio signal to determine that a first segment of the audio signal is in a first sound class and a second segment of the audio signal is in a second sound class; and determine a plurality of features of the audio signal, wherein the plurality of features are determined based on the first segment, the second segment, the first sound class, and the second sound class; generate metadata based on the plurality of features after capturing the video recording, wherein the metadata comprises a plurality of parameters to remix the first segment and the second segment in a mixed audio signal for the video recording; and store a video container comprising the video signal, the audio signal, and the metadata.

Some implementations may include a method for digital processing of audio for a video recording, including: receiving a front video signal from a front camera of a device capturing a front field of view, a rear video signal from a rear camera of the device capturing a rear field of view, and an audio signal from one or more microphones of the device capturing a sound field; digitally processing the audio signal to: identify voices of persons captured in the front field of view and the rear field of view, and ambient sounds of sound sources outside of the front field of view and the rear field of view; and generate an audio track to enable an audio renderer to render the voices, and selectively attenuate the ambient sounds, during playback of the front video signal and the rear video signal concurrently; and storing a video container comprising the front video signal, the rear video signal, and the audio track.

Some implementations may include a device for digital processing audio, the device including a front camera to capture a front field of view; a rear camera to capture a rear field of view; one or more microphones to capture a sound field; a memory, and one or more processors configured to: receive a front video signal from the front camera, a rear video signal from the rear camera, and an audio signal from the one or more microphones; digitally process the audio signal to: identify voices of persons captured in the front field of view and the rear field of view, and ambient sounds of sound sources outside of the front field of view and the rear field of view; and generate an audio track to enable an audio renderer to render the voices, and selectively attenuate the ambient sounds, during playback of the front video signal and the rear video signal concurrently; and store a video container comprising the front video signal, the rear video signal, and the audio track. Other aspects are also described and claimed.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is an example of capturing a video recording.

FIG. 2 is an example of a system that may be utilized by a device of FIG. 1 for capturing video recordings.

FIG. 3 is an example of a system for digital processing audio for video recordings.

FIG. 4 is an example of a remix analyzer for digitally processing audio for video recordings.

FIG. 5 is an example of a process for digital processing of audio for video recordings.

FIG. 6 is an example of capturing a video recording with voices in fields of views.

FIG. 7 is an example of a process for digital processing of audio to identify voices in fields of views.

### DETAILED DESCRIPTION

A user can utilize an electronic device, such as a smartphone or tablet computer, to capture a video recording. The video recording may include a video signal of a scene being produced by a camera of the device and an audio signal of the scene being produced by one or more microphones of the device. However, the video recording may have higher levels of ambient sound than professional content might have due to the one or more microphones being far from the subject and co-located with camera of the device. Further, generating the video recording may involve significant power and/or resources, and/or may fail to capture voices of interest.

Implementations of this disclosure address problems such as these by digitally processing an audio signal generated with a video recording, concurrently, in real time, with capture of the video recording, to calculate statistics of the audio signal. The statistics may be used to generate metadata immediately after stopping the capture of the video recording. The metadata may then be written to a track of a video container (e.g., a movie file) that also contains the original audio and video signals (unprocessed) from the video recording in separate tracks. The metadata may enable an efficient, low power capture of audio rendering data by a device that subsequently enables audio rendering further downstream. Then, at a later time, an audio renderer of an AVP can render the original audio signal (unprocessed) based on mixing that utilizes the metadata. In some cases, the metadata may be used to generate a video container that includes the video signal and a mixed audio signal to pre-render audio for playback (e.g., a second movie file, or derivative file)

In some implementations, the device may utilize a low power audio analysis that runs at record time, computes parameters to enable remix of recorded audio, and/or stores the parameters in a metadata track of a movie file (deferred audio rendering). The metadata may then be used later at playback time to perform audio adjustments. The estimated parameters may include, for example, dialogue level (from a talker), ambience level (from ambient sound), equalization (EQ) for dialogue, EQ for ambience, and/or thresholds for dialogue and/or ambience dynamic range compressions (DRC). In some cases, additional classifiers may be used to control estimated parameters based on content type. In some cases, the parameters may be tuned based on expert labeled data. In some cases, the device may utilize a low power remix analyzer to estimate the parameters without performing the high fidelity audio processing that may be used later in a final playback.

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

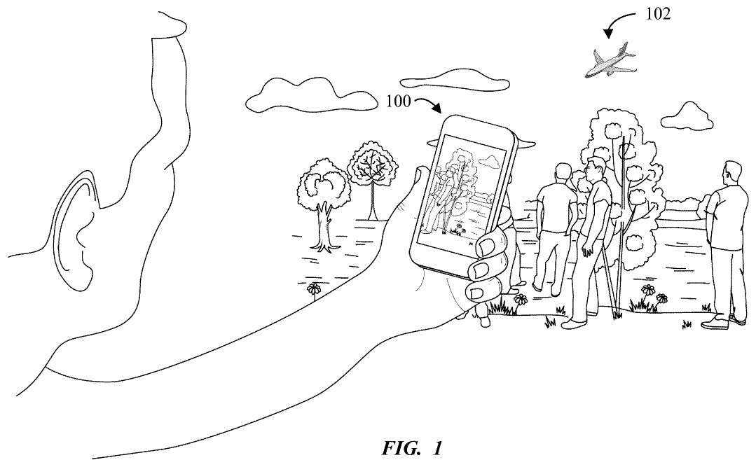

FIG. 1 shows an example of capturing a video recording of a scene. A user holding a portable, multi-function, electronic device 100, such as a smartphone, aims the device at a group of persons (talkers exchanging dialogue) while outdoors in a park-like setting. The device 100 may include a camera and one or more microphones used to capture the video recording, such as a front facing camera, a rear facing camera, and/or speakers that may be built-in. The front facing camera may be on the same side as the display of the device and may be used to capture the user, such as a first person holding or supporting the device and talking. The rear facing camera may be on the opposite side of the device and may be used to capture the scene, such as a second person, and possibly others, talking.

The user might have the device 100 positioned relatively far from the group, and the scene might include undesirable background noise 102, such as a passing airplane. As a result, the video recording may have more ambient sound than desired resulting in the dialogue picked up by the microphones being less clear. Using the processes and/or algorithms described herein, audio rendering for playback (sound output) of the captured sound in the scene can be intelligently, efficiently, and automatically improved with reduced power consumption by the device 100. It should be noted that although a smartphone is described as an example, the techniques described herein may also be implemented in other portable devices, such as a tablet computer, a camcorder, and a laptop computer.

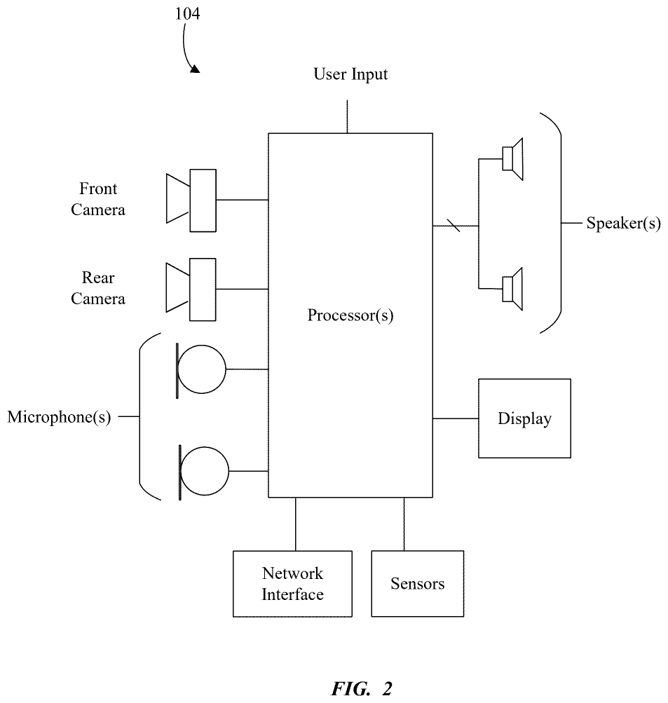

FIG. 2 is an example of a system 104 that may be utilized by the device 100 for capturing video recordings. The system 104 may include one or more of the structures shown. The structures may include, for example, one or more processors (e.g., to execute instructions), memories, displays (e.g., to present a viewfinder to the user and for playback of video), speakers (e.g., for playback of rendered audio), front facing camera (e.g., to record a user that may be talking), a rear facing camera (e.g., to record one or more persons in the scene), one or more microphones (e.g., to pick up or capture a sound field, including dialogue of the talkers, ambient sound in the environment, and/or other sounds), environment sensors (e.g., Lidar to detect distances to talkers and/or objects in the scene), user inputs (e.g., wireless controllers, volume and/or mute buttons, etc.), and/or a network interface. The one or more processors may execute instructions stored in memory to enable the device to perform digital processing of audio for video recordings as described herein.

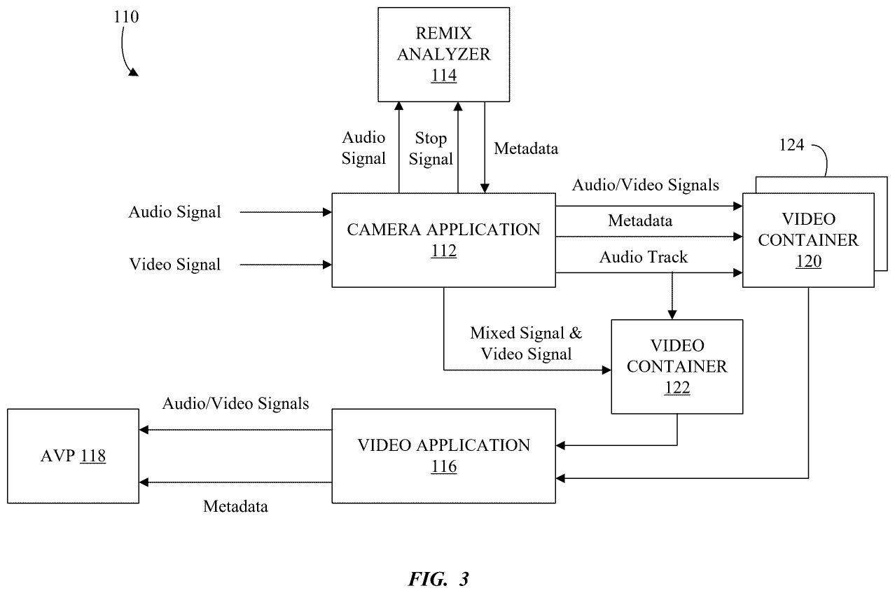

FIG. 3 is an example of a system 110 for digital processing audio for video recordings. The system 110 may include a camera application 112, a remix analyzer 114, a video application 116, and an audio/video player 118 (AVP). The system 110 may be utilized by the device 100 and/or a playback device. For example, the device 100 could be a smartphone that implements the camera application 112 and/or the remix analyzer 114 and that communicates with a playback device, such as a smart TV with an immersive surround sound system that implements the video application 116 and/or the audio/video player 118 for playback. In another example, the device 100 could be a smartphone, tablet, or laptop that implements each of the camera application 112, the remix analyzer 114, the video application 116, and the audio/video player 118 for playback.

One or more processors of the device 100 may execute instructions stored in memory to perform tasks, including utilizing the camera application 112 to capture a video recording. The video recording may include a video signal of a scene produced by one or more of the cameras and an audio signal of the scene picked up by the one or more microphones of the device 100. In some cases, the device 100 can pre-process the audio signal by converting the audio signal into one or more ambisonics, e.g., first order ambisonics (FOA) or higher order ambisonics (HOA) signals.

While capturing the video recording, the camera application 112 can communicate with the remix analyzer 114 to digitally process the audio signal. The remix analyzer 114 can perform a low power audio analysis that runs at record time to compute parameters concurrently with capture to enable remix of the recorded audio while analyzing the recording from start to stop. The remix analyzer 114 can determine segments of the audio signal to be in classes, such as a first segment of the audio signal in a first sound class (e.g., dialogue from a talker, or a singing voice) and a second segment of the audio signal in a second sound class (e.g., ambient sound, or a musical instrument).

Further, while capturing the video recording, the remix analyzer 114 can determine features of the audio signal. The features may include levels and/or frequency distributions of the segments in the classes. For example, features including levels and/or frequency distributions of the first segment in the first sound class (e.g., dialogue) and levels and/or frequency distributions of the second segment in the second sound class (e.g., ambient sound) may each be determined. Thus, the device 100 can calculate statistics of the audio signal from the features, while capturing the video recording, to enable a fast computation at the end of recording.

After capturing the video recording (e.g., when the camera application 112 receives input that the user has provided a stop indication), the remix analyzer 114 can transition to performing a computation to compute parameters to enable remix of the recorded audio. This may be performed by utilizing lightweight, power limited modeling of the remix analyzer 114 (e.g., lower power audio rendering with decreased fidelity). The parameters may include, for example, dialogue level (based on each voice from a talker, from the front and/or rear of the device), ambience level (from ambient sound), EQ for dialogue, EQ for ambience, and/or thresholds for dialogue and/or ambience DRCs. Responsive to the indication that capture of the video recording has stopped (stop signal), the remix analyzer 114 generates metadata including the parameters based on the features. The parameters can enable remixing of the segments later to produce a mixed audio signal for the video recording (also referred to as deferred audio rendering). For example, the parameters may enable an audio/video player, such as the audio/video player 118 further downstream, to remix the first segment (e.g., dialogue) and the second segment (e.g., ambient sound), with specified gains, EQs, DRCs, etc. from the metadata, utilizing more expansive, power intensive modeling (e.g., higher power audio rendering with increased fidelity).

The metadata may be time-varying through multiple time steps to specify different portions of the video recording as having different adjustments to the audio signal. For example, the metadata may specify that a first portion of the video recording has one set of adjustments to ambient sound and/or dialogue, and a second portion of the video recording has another set of adjustments to ambient sound and/or dialogue that may be different. Thus, the metadata may be dynamic, with the parameters indicated by the metadata specifying different adjustments to the audio signal at different times of the video recording.

The camera application 112 receives the metadata and stores it in a video container 120 (e.g., a movie file). The video container 120 also stores the video signal and the audio signal from the recording. In particular, the video container 120 preserves the video signal and the audio signal as originally captured by the video recording, e.g., as original, unprocessed audio signals (microphone signals) and video signals, stored non-destructively, without changing the original content. The video container 120 includes the metadata to provides hints to an audio renderer as to how to remix the audio signal. This efficiently enables a deferred audio rendering by an audio/video player further downstream, reducing power consumption by the device 100 while capturing the video recording.

In some implementations, the camera application 112 can also use the metadata to generate a video container 122 (e.g., a second movie file, or derivative file). The video container 122 can include the video signal and a mixed audio signal, mixed based on the metadata, to pre-render audio for playback by an audio/video player. The video container 120 and the video container 122 can be stored together in the system 110 at the same time (e.g., on the device 100 and/or streamed to a database).

In some cases, the video container 122 may be generated based on a trigger event detected by the device 100. The trigger event may indicate that more processing and/or power consumption for this task is now available, e.g., to perform generation of the video container 122 in the background. For example, the trigger event may indicate that the device 100 is only performing lower priority tasks (e.g., refreshing data, screens, etc.), and/or that higher priority tasks (e.g., receiving and/or responding to user input) are not being executed, such as when the device 100 is charging or offline. As a result, the device 100 can generate the video container 122 with reduced impact to the user. In another example, the trigger event may indicate a demand for the pre-rendered audio of the video container 122, such as the device 100 performing a share or send task to share a movie, causing generation of the file.

Thus, the device 100 can digitally process the audio signal from the video recording, analyzing an entire track at a time, in real time with capture of the video recording by the user, to calculate summary statistics of the audio signal (from beginning to end of the video recording) immediately upon stopping the capture. The statistics may then be used to generate the metadata including the parameters for downstream mixing of the audio signal. The metadata may be written to a track of the video container 120 that also contains the original audio and video signals in separate tracks. Additionally, or alternatively, the metadata may be used to generate the video container 122 including the mixed audio signal, which may occur based on the trigger event (e.g., a share or send task). The video container 122 may enable faster playback by an audio/video player 118 based on already including a mixed audio signal that is pre-rendered for playback.

The video application 116, and the audio/video player 118, can access the video container 120 and utilize the metadata to render the audio signal for playback. The metadata stored in the video container 120 may enable the audio renderer of the audio/video player 118 to render the original audio signal (unprocessed) based on its own, subsequent, downstream mixing that utilizes the earlier upstream metadata, such as by converting the audio signal into an FOA or HOA track. In other words, the audio/video player 118 can apply remix decisions of the remix analyzer 114 further downstream at a later time, including to generate speaker signals for playback of a rendered, mixed audio signal via speakers. This may result in the device 100 reducing power consumption by deferring the audio rendering, with the benefit of metadata for the audio rendering still produced from statistics captured while recording the audio signal. This may also result in a video container that can be continuously accessed and updated many times to produce variations, such as a video container 124. For example, in some cases, the device 100 can change the metadata stored in the video container 120 after the video container 120 has already been generated and stored. The remix analyzer 114 can perform additional processing of the captured statistics to increase audio processing fidelity, indicated by updated metadata in the video container 124, including based on software updates. In some cases, the remix analyzer 114 can perform the further processing based on a trigger event detected by the device 100, which may indicate that more processing and/or power consumption for this task is available. For example, the trigger event may indicate that the device 100 is only performing lower priority tasks (refreshes), and/or that higher priority tasks (responding to user input) are not being executed, as described above.

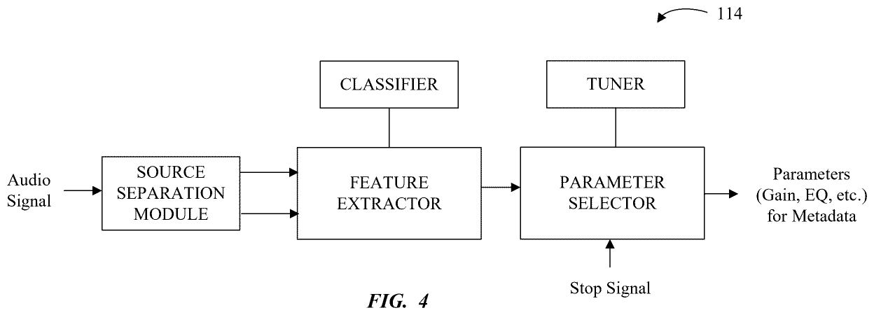

FIG. 4 is an example of utilizing the remix analyzer 114 to digitally process audio for video recordings. The remix analyzer 114 may be a low power audio analyzer that runs simultaneously while capturing the video recording. The remix analyzer 114 can estimate parameters for audio adjustment without performing the high fidelity audio processing used in by the audio/video player 118.

The remix analyzer 114 can receive an audio signal from the camera application 112 (from the one or more microphones). The remix analyzer 114 can utilize a source separation module to determine that segments of the audio signal are in classes, such as a first segment of the audio signal in a first sound class (e.g., dialogue from a talker, or a singing voice) and a second segment of the audio signal in a second sound class (e.g., ambient sound, or a musical instrument). The remix analyzer 114 can then utilize a feature extractor, receiving input from a classifier, to determine features of the audio signal based on the first segment, the second segment, the first sound class, and the second sound class. The features may include levels and frequency distributions of the segments in the classes. In some cases, the remix analyzer 114 can utilize a classifier to determine the features, such as a neural network.

The remix analyzer 114 can then utilize a parameter selector (finalizer) to determine parameters for the metadata (also referred to as remix parameters). The parameters, based on the features, may enable remixing the segments of the audio signal in a mixed audio signal for the video recording. For example, the parameters may include dialogue level (from a talker), ambience level (from ambient sound), EQ for dialogue, EQ for ambience, and/or thresholds for dialogue and/or ambience DRCs. The parameter selector may output the parameters to generate metadata based on the stop signal, e.g., indicating capture of the video recording has stopped.

The metadata may then be stored in a video container (e.g., the video container 120) as a metadata track, and/or may be used to generate a derivative video container (e.g., the video container 122) that is pre-rendered for faster playback.

Thus, the remix analyzer 114 can estimate parameters for audio adjustment, without performing the high fidelity audio processing used in a final playback, such as the audio/video player 118. This may enable the device 100 to utilize low power. In some cases, additional classifiers may be used to control estimated parameters based on content type. For example, in addition to the first sound class corresponding to dialogue (e.g., talkers) and the second sound class corresponding to ambient sound (e.g., an airplane passing), a third sound class may correspond to music in the scene (e.g., a song playing) based on an additional classification. The parameters may enable remix of each of the segments to produce the mixed audio signal (e.g., each of the first, second, and third segments). Additionally, in some cases, a tuner may be utilized to further tune the parameters based on expert labeled data.

Reference is now made to flowcharts of examples of processes for digital processing of audio for video recordings. The processes can be executed using computing devices, such as the systems, hardware, and software described with respect to FIGS. 1-5. The processes can be performed, for example, by executing a machine-readable program or other computer-executable instructions, such as routines, instructions, programs, or other code. The operations of the processes or other techniques, methods, or algorithms described in connection with the implementations disclosed herein can be implemented directly in hardware, firmware, software executed by hardware, circuitry, or a combination thereof.

For simplicity of explanation, the processes are depicted and described herein as a series of operations. However, the operations in accordance with this disclosure can occur in various orders and/or concurrently. Additionally, other operations not presented and described herein may be used. Furthermore, not all illustrated operations may be required to implement a process in accordance with the disclosed subject matter.

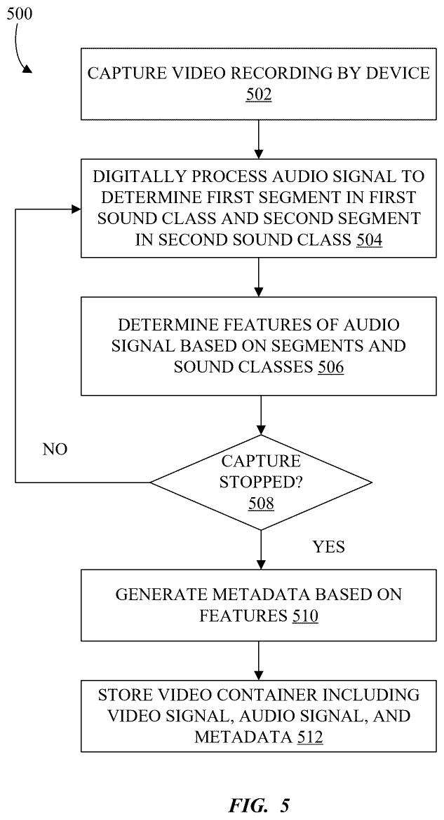

FIG. 5 is an example of a process 500 for digital processing of audio for video recordings. At operation 502, the device 100 can capture a video recording. The video recording may include a video signal of a scene being produced by the camera and an audio signal of the scene being produced by the one or more microphones of the device 100. At operation 504, while capturing the video recording, the device 100 can digitally process the audio signal to determine that a first segment of the audio signal is in a first sound class and a second segment of the audio signal is in a second sound class. At operation 506, while capturing the video recording, the device 100 can determine a plurality of features of the audio signal. The plurality of features may be determined based on the first segment, the second segment, the first sound class, and the second sound class. At operation 508, the device 100 can determine whether capture of the video recording has stopped. If capture of the video recording has not stopped (No), the device 100 can continue to digitally process the audio signal at operation 502 and determine the plurality of features at operation 504. However, if capture of the video recording has stopped (Yes), at operation 510, the device 100 can generate metadata based on the plurality of features. The metadata may include a plurality of parameters to remix the first segment and the second segment in a mixed audio signal for the video recording. Then, at operation 512, the device 100 can store a video container including the video signal, the audio signal, and the metadata.

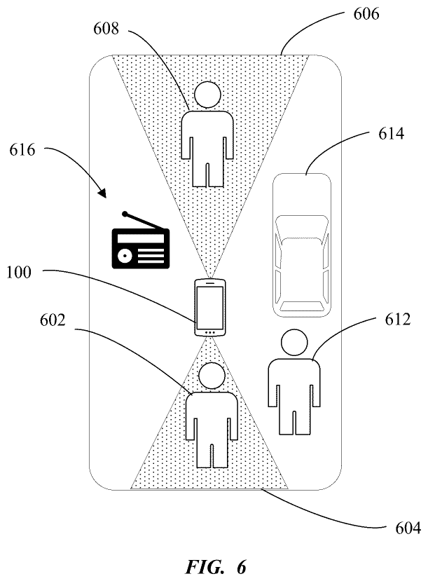

FIG. 6 is an example of capturing a video recording with voices in fields of views. A first person 602 (a user) can use the device 100 to capture a video recording. The video recording may include a front video signal from the front camera of the device capturing a front field of view 604 (e.g., capturing in-frame for front, in a first cardioid pattern), a rear video signal from the rear camera of the device capturing a rear field of view 606 (e.g., in-frame for back, in a second cardioid pattern), and an audio signal from the one or more microphones of the device 100 to capture a sound field. The video recording may simultaneously include the first person 602 talking in the front field of view 604 (e.g., the user interacting with the scene) and the second person 608 talking in the rear field of view 606 (e.g., the scene, which might include undesirable background noise 102). The video recording might also include ambient sounds of ambient sound sources that are outside of the front field of view 604 and outside of the rear field of view 606, such as a third person 612 talking (e.g., a passerby), an automobile 614 starting up, a radio 616 playing, a passing airplane, etc. These ambient sound sources may be positioned to the sides of the device 100. For example, the device 100 can receive user input (e.g., a button of the device 100, such as via the display) to simultaneously activate the front camera to capture the front field of view 604, the rear camera to capture the rear field of view 606, and the one or more microphones to capture the sound field, in a preconfigured, selected mode (e.g., front-rear in-frame mode).

The device 100, capturing the video recording in the selected mode, can digitally process the audio signal to identify voices of persons captured in the front field of view 604 (such as a first voice of the first person 602) and the rear field of view 606 (such as a second voice of the second person 608), and ambient sounds of sound sources outside of the front field of view 604 and the rear field of view 606, such as a third voice of the third person 612, the automobile 614, the radio 616, etc. The device 100 can further digitally process the audio signal to generate an audio track (see FIG. 3) to enable an audio renderer (the audio/video player 118) to render the voices captured in the front field of view 604 (the first voice of the first person 602) and the rear field of view 606 (the second voice of the second person 608), and selectively attenuate the ambient sounds (the third voice of the third person 612, the automobile 614, the radio 616). This may include converting the audio signal to ambisonics (e.g., FOA, HOA) to enable the audio renderer to position the voices. The audio track may be generated to be played during playback of the front video signal and the rear video signal concurrently (e.g., picture in a picture, such as the front video signal as a picture in a picture of the rear video signal, concurrent with playback of the audio track).

The device 100 can store a video container (video container 120) including the front video signal, the rear video signal, the audio track, and metadata. The video container preserves the front video signal, the rear video signal, and the audio signal as originally captured by the video recording, e.g., as original, unprocessed audio signals (microphone signals) and video signals, stored non-destructively, without changing the original content. The metadata (front-rear in-frame metadata) may be generated based on the video recording including both the front video signal (from the front camera) and the rear video signal (from the rear camera) as detected by the device 100. This metadata may indicate the selected mode of capturing, front-rear in-frame mode, based on the simultaneous recording of the front video signal and the rear video signal.

Further, this metadata may be added to the video container (video container 120), to indicate to an audio renderer (e.g., the audio/video player 118) to render the voices captured in the front field of view (the first voice of the first person 602) and the rear field of view (the second voice of the second person 608) and to selectively attenuate ambient sounds outside of the field of view. The device 100 can also generate a second, rendered video container (e.g., video container 122, a derivative file) that includes the front-rear in-frame rendering, without metadata.

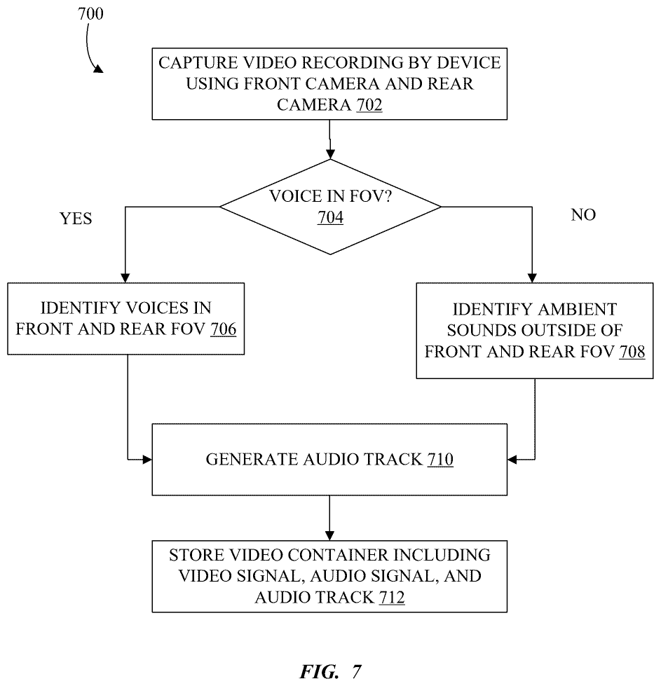

FIG. 7 is an example of a process 700 for digital processing of audio to identify voices in fields of views. At operation 702, the device 100 can capture a video recording and generate metadata. The video recording may include a front video signal from the front camera of the device capturing a front field of view, a rear video signal from the rear camera of the device capturing a rear field of view, and an audio signal from one or more microphones of the device capturing a sound field.

Metadata (e.g., front-rear in-frame metadata) may be generated based on the video recording including both a front video signal (from the front camera) and the rear video signal (from the rear camera) as detected. The metadata may indicate the selected mode includes capturing in-frame for front and in-frame for back (e.g., the front-rear in-frame mode). The metadata may be added to a video container (video container 120) to later indicate the mode to an audio renderer. If the front-rear in-frame mode is disabled (e.g., either the front video signal or the rear video signal is not active), another mode, or default mode, may be indicated in the video container, such as by a lack of the metadata, or presence of alternate metadata. In some cases, the device 100 can calculate statistics of the audio signal while capturing the video recording (e.g., via the remix analyzer 114).

After capture of the video recording has stopped (e.g., stop signal of FIG. 3), the metadata generated based on the video recording including (front-rear in-frame metadata) may be read from the video container (e.g., video container 120) and used to perform subsequent offline processing (post recording) to generate a second, rendered video container (e.g., video container 122). If the front-rear in-frame metadata is ON, then the in-frame for front and back mode may be applied to generate the second, rendered video container, such as isolating both front and rear voices of persons. Additionally, the isolated voices, front and rear, may be re-panned to a center location and stored as an object track with location metadata in the second, rendered video container, such as for aesthetic improvement. Alternatively, if the front-rear in-frame metadata is OFF or not present, then another mode, or default mode (other than then the in-frame for front and back mode) may be applied to generate the second, rendered video container, such as only isolating the voice of the person in the direction of the camera that is recording (the front or the rear).

For example, at operation 704, based on the front-rear in-frame metadata ON, the device 100 can digitally process the audio signal to identify voices of persons captured in the fields of view (FOV), e.g., the front field of view and the rear field of view, and ambient sounds of sound sources outside of the fields of view. For example, this may isolate voices from the front and back and not on the sides to enable a controllable reduction of ambient sounds. If a sound from a sound source is identified as a voice of a person in a field of view (Yes), the voice may be identified at operation 706. If a sound from a sound source is not identified as a voice of a person in a field of view (No), the sound may be identified as an ambient sound (including of sound sources outside of the field of view) at operation 708.

At operation 710, the device 100 can generate an audio track to enable an audio renderer (e.g., the audio/video player 118) to render the voices, and selectively attenuate the ambient sounds, during playback of the front video signal and the rear video signal concurrently. The audio track may include metadata (e.g., front-rear in-frame metadata, location metadata, etc.). In some cases, the audio track may be one of a plurality of audio tracks generated based on the identifications. For example, the device 100 can generate a mono track to centralize the audio, an ambisonics track to enable the audio renderer to position the voices in a 3D sound field, etc.

Then, at operation 712, the device 100 can store a video container (e.g., video container 120) including the video signal, the audio signal, and the metadata. Further, the device 100 can perform subsequent offline processing (post recording) to generate a second, rendered video container (e.g., video container 122) without the metadata. Additionally, the device 100 may re-pan the isolated voices to a center location, and store them as an object track with location metadata in the second, rendered video container, e.g., for aesthetic improvement. A video application can subsequently play back the video recording via the first video container (using the metadata) and/or the second, rendered video container (using the front-rear in-frame rendering, without metadata). This may include, for example, displaying to a screen the front video signal as a picture in a picture of the rear video signal with playback of the audio track based on the front-rear in-frame metadata. This may also include re-panning the isolated voices to a center location based on the location metadata.

As described above, one aspect of the present technology is the gathering and use of data available from specific and legitimate sources for digital processing of audio to identify voices in fields of views. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for digital processing of audio to identify voices in fields of views. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of digital processing of audio to identify voices in fields of views, the present technology can be configured to allow users to select to “opt in” or “opt out” of participation in the collection of personal information data during registration for services or anytime thereafter.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

In utilizing the various aspects of the embodiments, it would become apparent to one skilled in the art that combinations or variations of the above embodiments are possible for digital processing of audio to identify voices in fields of views. Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A method for digital processing audio, comprising:
receiving a front video signal from a front camera of a device capturing a front field of view, a rear video signal from a rear camera of the device capturing a rear field of view, and an audio signal from one or more microphones of the device capturing a sound field;
digitally processing the audio signal to:
identify voices of persons captured in the front field of view and the rear field of view, and ambient sounds of sound sources outside of the front field of view and the rear field of view; and
generate an audio track to enable an audio renderer to render the voices, and selectively attenuate the ambient sounds, during playback of the front video signal and the rear video signal concurrently; and
storing a video container comprising the front video signal, the rear video signal, and the audio track.

2. The method of claim 1, wherein the voices include a first voice of a first person identified in the front field of view, and a second voice of a second person identified in the rear field of view.

3. The method of claim 2, wherein the ambient sounds include voices of persons outside of the front field of view and the rear field of view.

4. The method of claim 1, wherein the audio track includes metadata to indicate that a front-rear in-frame mode is enabled.

5. The method of claim 1, wherein the audio track is a one of a plurality of audio tracks that includes a mono track and an ambisonics track.

6. The method of claim 1, wherein the audio signal is converted by the digital processing to ambisonics to enable the audio renderer to position the voices.

7. The method of claim 1, wherein the playback includes embedding the front video signal as a picture in a picture of the rear video signal.

8. The method of claim 1, wherein the video container preserves the front video signal, the rear video signal, and the audio signal as originally captured by a video recording.

9. The method of claim 8, further comprising:
calculating statistics of the audio signal while capturing the video recording.

10. The method of claim 1, further comprising:
receiving user input to simultaneously activate the front camera to capture the front field of view, the rear camera to capture the rear field of view, and the one or more microphones to capture the sound field.

11. The method of claim 1, further comprising:
receiving user input via to selectively attenuate the ambient sounds.

12. A device for digital processing audio, comprising:
a front camera to capture a front field of view;
a rear camera to capture a rear field of view;
one or more microphones to capture a sound field; and
one or more processors configured to:
receive a front video signal from the front camera, a rear video signal from the rear camera, and an audio signal from the one or more microphones;
digitally process the audio signal to:
identify voices of persons captured in the front field of view and the rear field of view, and ambient sounds of sound sources outside of the front field of view and the rear field of view; and
generate an audio track to enable an audio renderer to render the voices, and selectively attenuate the ambient sounds, during playback of the front video signal and the rear video signal concurrently; and
store a video container comprising the front video signal, the rear video signal, and the audio track.

13. The device of claim 12, wherein the voices include a first voice of a first person identified in the front field of view, and a second voice of a second person identified in the rear field of view.

14. The device of claim 13, wherein the ambient sounds include voices of persons outside of the front field of view and the rear field of view.

15. The device of claim 12, wherein the audio track includes metadata to indicate that a front-rear in-frame mode is enabled.

16. The device of claim 12, wherein the audio track is a one of a plurality of audio tracks that includes a mono track and an ambisonics track.

17. The device of claim 12, wherein the audio signal is converted by the digital processing to ambisonics to enable the audio renderer to position the voices.

18. The device of claim 12, further comprising:
a display, wherein the video container is played back to the display with the front video signal embedded as a picture in a picture of the rear video signal.

19. The device of claim 18, wherein the display receives user input to simultaneously activate the front camera to capture the front field of view, the rear camera to capture the rear field of view, and the one or more microphones to capture the sound field.

20. The device of claim 18, wherein the display receives user input to selectively attenuate the ambient sounds.
